(19) United States
(12) Patent Application Publication
(10) Pub. No.: US 2010/0306860 A1
(43) Pub. Date: Dec. 2, 2010

(54) USING A CUSTOM MEDIA LIBRARY TO SECURE DIGITAL MEDIA CONTENT

(76) Inventor: Hank RISAN, Santa Cruz, CA (US)

Correspondence Address: MEDIA RIGHTS TECHNOLOGIES C/O WAGNER BLECHER LLP, 123 WESTRIDGE DRIVE, WATSONVILLE, CA, 95076, US

(21) Appl. No.: 12/475,037

(22) Filed: May 29, 2009

(51) Int. Cl. G06F 21/00; G06F 17/00

(52) U.S. Cl. 726/33; 707/E17.009

(57) ABSTRACT

A system and method for using a custom media library to secure digital media content on a computing system is disclosed. The method includes directly linking the custom media library with a copyright compliance mechanism (CCM)-enabled playback/recording application. In addition, the custom media library generates a new pathway distinct from a commonly used data pathway of the CCM-enabled playback/recording application and a media rendering subsystem of an operating system. Also, a CCM is alerted to monitor a plurality of media subsystems of the computing system. In so doing, a raw media file may be securely passed from the CCM-enabled playback/recording application via the custom media library and over the new pathway to a media subsystem of the operating system that is monitored by the CCM, such that the raw media file is rendered, playable and copyable in a secure environment.

### FIELD

Embodiments of the present technology relates generally to the field of copyright protection.

### BACKGROUND

Presently, if a user wants to buy a particular song or video, the media can be purchased and downloaded from the Internet. For example, an end user can access any of a number of media distribution sites, purchase and download the desired media and then listen or watch the media repeatedly.

In many cases, the media being purchased and downloaded will include some type of copyright protection. Basically, the copyright protection allows the owner of the copyrighted media to control distribution of the media and receive the proper copyright royalties for the use of the copyright protected media. For example, if the downloaded media is copyright protected, copyright royalties may be required by anyone copying, transmitting or subsequently downloading the protected media.

Presently, there are a number of applications that attempt to circumvent the copyright protection. One technique for illegally copying digital media captures outgoing audio data by establishing a system hook for the purpose of intercepting calls made by secure audio playback applications to standard non-secure operating system services that are used for the rendering of audio data.

For example, when a hooked system service is called, the system hook will gain control first, allowing a recording application to perform application-specific processing, such as capturing an illegal copy of the digital media, before passing control to the actual operating system service. The system hook will thus allow the recording application to capture output data without the use of a virtual audio device driver or plug-in module.

Under Title 17, the copyright owner has legal standing to require media distributors to protect the copyrighted material with technological measures.

### SUMMARY

A system and method for using a custom media library to secure digital media content on a computing system is disclosed. The method includes directly linking the custom media library with a copyright compliance mechanism (CCM)-enabled playback/recording application. In addition, the custom media library generates a new pathway distinct from a commonly used data pathway of the CCM-enabled playback/recording application and a media rendering subsystem of an operating system. Also, a CCM is alerted to monitor a plurality of media subsystems of the computing system. In so doing, a raw media file may be securely passed from the CCM-enabled playback/recording application via the custom media library and over the new pathway to a media subsystem of the operating system that is monitored by the CCM, such that the raw media file is rendered, playable and copyable in a secure environment.

### BRIEF DESCRIPTION OF THE DRAWINGS

FIG. 1 is a block diagram of various exemplary functional components of a copyright compliance mechanism (CCM) in accordance with an embodiment of the present invention.

FIG. 2 is a block diagram of a custom media library utilized to secure digital media content, in accordance with an embodiment of the present technology

FIG. 3 is a block diagram of a system for enhancing copyright revenue generation, in accordance with an embodiment of the present invention.

FIG. 4 is a block diagram of a flow chart of a method for enhancing copyright generation, in accordance with an embodiment of the present invention.

FIG. 5 is a block diagram of a flow chart of a method for determining if secure media copying of digital media content in a usage protected frame-based work is allowed, in accordance with an embodiment of the present invention.

FIG. 6 is a block diagram of a flow chart of a method for secure media copying of digital media content in a usage protected frame-based work, in accordance with an embodiment of the present invention.

FIG. 7 is a block diagram of an exemplary computer system in accordance with one embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

### Overview

According to 17 U.S.C. 106 and 114, an owner of copyright in a sound recording has exclusive rights to the sound recording. Copyright law also requires a plurality of copyright royalties paid to the copyright owner for the use of copyrighted work, such as but not limited to performance royalties and publishing royalties. The royalty rates are set by the Copyright Royalty Board. In order for a copyright owner to enforce and collect copyright royalties, the copyright owner must have a valid copyright that is registered with the United States Copyright Office. A way to protect a copyright protected work and ensure payment of copyright royalties is through the use of technological measures that effectively control access to the copyright protected work, as described in 17 U.S.C. sections 1201, 1202 and 1001. Thus, the copy management information acts as a technological measure which “effectively controls access to a work” by requiring the application of information, with the authority of the copyright owner, to gain access to the work.

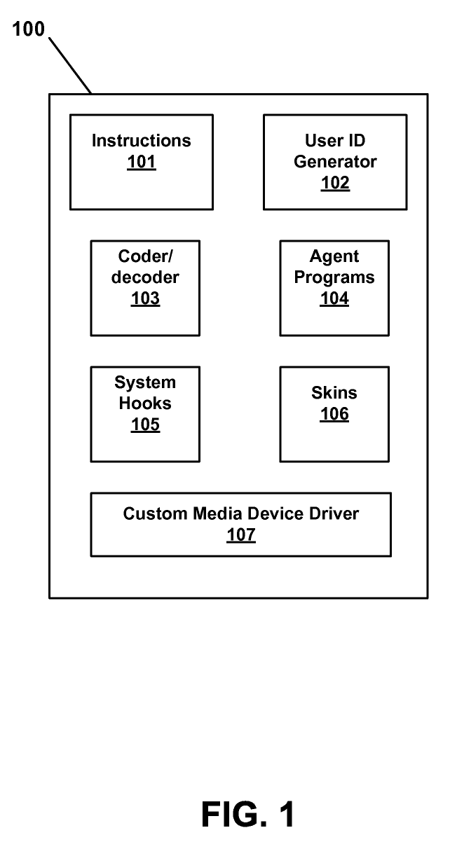

FIG. 1 is a block diagram of an exemplary copyright compliance mechanism (CCM) 100, for controlling distribution of, access to, and/or copyright compliance of media files, in accordance with an embodiment of the present invention. In one embodiment, CCM 100 contains one or more software components and instructions for enabling compliance with DMCA (digital millennium copyright act) restrictions and/or RIAA (recording industry association of America) licensing agreements regarding media files. In one embodiment, although copyright is used in the description, another type of usage protection including copy, transfer or playback limitations may also be utilized within the framework described herein. In other words, in one embodiment, the present technology is well suited for numerous types of usage protection including, but not limited to, copyright protection. In general, the usage protection allows the owner of the usage restricted media to control distribution of the media.

There are currently two types of copyright licenses recognized by the DMCA for the protection of broadcasted copyrighted material. One of the broadcast copyright licenses is a compulsory license, also referred to as a statutory license. A statutory license is defined as a non-interactive license, meaning the user cannot select the song. Further, a caveat of this type of broadcast license is that a user must not be able to select a particular music file for the purpose of recording it to the user's computer system or other storage device. Another caveat of a statutory license is that a media file is not available more than once for a given period of time. In one example, the period of time can be three hours.

The other type of the broadcast license recognized by the DMCA is an interactive licensing agreement. An interactive licensing agreement is commonly with the copyright holder, e.g., a record company, the artist, where the copyright holder grants permission for a server to broadcast copyrighted material. Under an interactive licensing agreement, there are a variety of ways that copyrighted material, e.g., music files, can be broadcast. For example, one manner in which music files can be broadcast is to allow the user to select and listen to a particular sound recording, but without the user enabled to make a sound recording. This is commonly referred to as an interactive with “no save” license, meaning that the end user is unable to save or store the media content file in a relatively permanent manner. Additionally, another manner in which music files can be broadcast is to allow a user to not only select and listen to a particular music file, but additionally allow the user to save that particularly music file to disc and/or burn the music file to CD, MP3 player, or other portable electronic device. This is commonly referred to as an interactive with “save” license, meaning that the end user is enabled to save, store, or burn to CD, the media content file.

It is noted that the DMCA allows for the “perfect” reproduction of the sound recording. A perfect copy of a sound recording is a one-to-one mapping of the original sound recording into a digitized form, such that the perfect copy is virtually indistinguishable and/or has no audible differences from the original recording.

In one embodiment, CCM 100 is installed into each client computer system. Alternatively, CCM 100 can be, in another embodiment, externally disposed and communicatively coupled with a client computer system. In one embodiment, portions of components, entire components and/or combinations of components of CCM 100 can be readily updated to reflect changes or developments in the DMCA, changes or developments in copyright restrictions and/or licensing agreements that pertain to any media file, changes in current media player applications and/or the development of new media player applications.

Referring to FIG. 1, in one embodiment, CCM 100 is shown to include instructions 101 for enabling a client computer system to interact with a web server or content server on a network. CCM 100 also includes, a user ID generator 102, for generating a user ID or user key, and one or more cookie(s) which contain(s) information specific to the user and the user's computer system. In one embodiment, the presence of a valid cookie(s) and a valid user ID/user key are verified by a web server before the remaining components of a CCM 100 can be installed. Additionally, the user ID/user key can contain, but is not limited to, the user's name, the user's address, the user's credit card number, verified email address, and an identity (usemame) and password selected by the user. Furthermore, the cookie can contain, but is not limited to, information specific to the user, information regarding the user's computer system, e.g., media applications thereon, a unique identifier such as a MAC (machine address code) address and/or an IP address, and other information specific to the user and the computer system operated by the user. The information regarding the client computer system, the user of the system, and an access key described herein can be collectively referred to as authorization data.

Advantageously, with information regarding the user and the user's computer system, a web server can determine when a user of one computer system has given their usemame and password to another user using another computer system. If the web server detects unauthorized sharing of usernames and passwords, it can block the computer system from future access to copyrighted media content available through the web server for any specified period of time, e.g., for a matter of minutes or hours to months, years, or longer.

Still referring to FIG. 1, CCM 100 further includes one or more coder/decoders (codec) 103 that, in one embodiment, is/are adapted to perform, but is/are not limited to, encoding/decoding of media files, compressing/decompressing of media files, detecting that delivered media files are encrypted as prescribed by CCM 100. In the present embodiment, coder/decoder 103 can also extract key fields from a header attached to each media content file for, in part, verification of the media file. In one embodiment, codec 103 can also perform a periodic and repeated check of the media file, while the media file is passed to the media player application, e.g., in a frame by frame basis or in a buffer by buffer basis, to ensure that CCM 100 rules are being enforced at any particular moment during media playback. It is noted that differing codec 103 can be utilized in conjunction with various types of copyrighted media content including, but not limited to, audio files, video files, graphical files, alphanumeric files and the like, such that any type of media content file can be protected in accordance with embodiments of the present invention.

With reference still to FIG. 1, CCM 100 also includes one or more agent programs 104 which are configured to engage in dialogs and negotiate and coordinate transfer of information between a computer system, a server, and/or media player applications, with or without recording functionality, that are operable within a client computer system. In addition, agent program 104 can be configured to maintain system state, verify that other components are being utilized simultaneously, to be autonomously functional without knowledge of the client, and can also present messages, e.g., error messages, media information, advertising, etc., via a display window or electronic mail. This enables detection of proper skin implementation and detection of those applications that are running. It is noted that agent programs are well known in the art and can be implemented in a variety of ways in accordance with the present embodiment.

CCM 100 also includes one or more system hooks 105. A system hook 105 is, in one embodiment, a library that is installed in a computer system and intercepts system wide events. For example, a system hook 105, in conjunction with skins 106, can govern certain properties and/or functionalities of media player applications operating within the client computer system, including, but not limited to, mouse click shortcuts, keyboard shortcuts, standard system accelerators, progress bars, save functions, pause functions, rewind functions, skip track functions, forward track preview, copying to CD, copying to a portable electronic device, and the like.

It is noted that the term governing, can refer to a disabling, deactivating, enabling, activating, etc., of a property or function. Governing can also refer to an exclusion of that function or property, such that a function or property may be operable but unable to perform in the manner originally intended. For example, during playing of a media file, the progress bar may be selected and moved from one location on the progress line to another without having an effect on the play of the media file.

In one embodiment, system hook 105 compares the information for the media player application operating in client computer system with a list of “signatures” associated with known media recording applications. In one embodiment, the signature can be, but is not limited to being, a unique identifier of a media player application and which can consist of the window class of the application along with a product name string which is part of the window title for the application. Advantageously, when new media player applications are developed, their signatures can be readily added to the signature list via an update of CCM 100 described herein.

The following C++ source code is exemplary implementation of the portion of a system hook 105 for performing media player application detection, in accordance with an embodiment of the present invention.

int
IsRecorderPresent(TCHAR * szAppClass,
TCHAR * szProdName)
{

| | |
|---|---|
| TCHAR | szWndText[_MAX_PATH]; /* buffer to receive title |

string for window */

| | |
|---|---|
| HWND | hWnd; /* handle to target window for operation */ |

```
    int nRetVal; /* return value for operation */
    /* initialize variables */
    nRetVal = 0;
    if ( _tcscmp(szAppClass, _T(“#32770”))
      == 0)
    {
        /* attempt to locate dialog box with specified window title */
        if ( FindWindow((TCHAR *) 32770, szProdName)
          != (HWND) 0)
        {
            /* indicate application found */
            nRetVal = 1;
        }
    }
    else
    {
        /* attempt to locate window with specified class */
        if ( (hWnd = FindWindow(szAppClass, (LPCTSTR) 0))
          != (HWND) 0)
        {
            /* attempt to retrive title string for window */
            if ( GetWindowText(hWnd,
                        szWndText,
                        _MAX_PATH)
              != 0)
            {
                /* attempt to locate product name within title string */
                if ( _tcsstr(szWndText, szProdName)
                  != (TCHAR *) 0)
                {
                    /* indicate application found */
                    nRetVal = 1;
                }
            }
        }
    }
    /* return to caller */
    return nRetVal;
}
```

In one embodiment, system hook 105 can also selectively suppress waveform input/output operations to prevent recording of copyrighted media on a client computer system. For example, system hook 105, subsequent to detection of bundled media player applications operational in a client computer system can stop or disrupt the playing of a media content file. This can be accomplished, in one embodiment, by redirecting and/or diverting certain data pathways that are commonly used for recording, such that the utilized data pathway is governed by CCM 100. This can be performed within a driver shim for a standard operating system waveform output device. Moreover, the driver shim may be configured to appear as the default waveform audio device to client level application programs. Thus, requests for processing of waveform audio input and/or output will pass through the driver shim prior to being forwarded to the actual waveform audio driver. Such waveform input/output suppression can be triggered by other components of CCM 100, e.g., agent 104, to be active when a recording operation is initiated by a client computer system during the play back of media files which are subject to the DMCA. The driver shim can be implemented for nearly any media in nearly any format including, but not limited to, audio media files and audio input and output devices.

The following C++ source code is an exemplary implementation of the portion of a system hook 105 for diverting and/or redirecting certain data pathways that are commonly used for recording of media content, in accordance with an embodiment of the present invention.

DWORD
_stdcall

| | |
|---|---|
| widMessage(UINT | uDevId, |

| | |
|---|---|
| UINT | uMsg, |
| DWORD | dwUser, |
| DWORD | dwParam1, |
| DWORD | dwParam2) |

{

| | |
|---|---|
| BOOL | bSkip; /* flag indicating operation to be skipped */ |

| | | |
|---|---|---|
| HWND | hWndMon; | /* handle to main window for |
| | | monitor */ |
| DWORD | dwRetVal; | /* return value for operation */ |

```
    /* initialize variables */
    bSkip = FALSE;
    dwRetVal = (DWORD) MMSYSERR_NOISUPPORTED;
    if (uMsg == WIDM_START)
    {
        /* attempt to locate window for monitor application */
        if ( (hWndMon = FindMonitorWindow( ))
          != (HWND) 0)
    {
            /* obtain selling for driver */
            bDrvEnabled = ( SendMessage(hWndMon,
                          uiRegMsg,
                            0,
                            0)
                    == 0)
                  ? FALSE : TRUE;
        }
        if (bDrvEnab led == TRUE)
        {
            /* indicate error in operation */
            dwRetVal = MMSYSERR_NOMEM;
            /* indicate operation to be skipped */
            bSkip = TRUE;
            }
    }
    if (bSkip == FALSE)
    {
        /* invoke entry point for original driver */
        dwRetVal = CallWidMessage(uDevId, uMsg, dwUser,
dwParam1, dwParam2);
    }
    /* return to caller */
    return dwRetVal;
}
```

When properly configured, system hook 105 can govern nearly any function or property within nearly any media player application that may be operational within a client computer system. In one embodiment, system hook 105 is a DLL (dynamic link library) file. It is further noted that system hooks can be implemented in nearly any operating system.

In FIG. 1, CCM 100 also includes one or more skins 106, designed to be installed in a client computer system. In one embodiment, skins 106 are utilized to assist in client side compliance with the DMCA regarding copyrighted media content. Skins 106 are customizable interfaces that, in one embodiment, are displayed on a display device of computer system and provide functionalities for user interaction of delivered media content. Additionally, skins 106 can also provide a display of information relative to the media content file including, but not limited to, song title, artist name, album title, artist bio, and other features such as purchase inquiries, advertising, and the like.

Furthermore, when system hook 105 is unable to govern a function of the media player application operable on a client computer system such that client computer system could be in non-compliance with DMCA and/or RIAA restrictions, a skin 106 can be implemented to provide compliance.

Differing skins 106 can be implemented depending upon the DMCA and/or RIAA restrictions applicable to each media content file. For example, in one embodiment, a skin 106 may be configured for utilization with a media content file protected under a non-interactive agreement and may not include a pause function, a stop function, a selector function, and/or a save function, etc. In another embodiment, skin 106 may be configured to be utilized with a media content file protected under an interactive “no save” agreement such that skin 106 may include a pause function, a stop function, a selector function, and for those media files having an interactive with “save” agreement, a save or a burn to CD function.

Still referring to FIG. 1, each skin 106 can have a unique name and signature and can be implemented, in part, through the utilization of an MD (message digest) 5 hash table or similar algorithm. An MD 5 hash table can be, in one implementation, a check-sum algorithm. Since modification of the skin would change the check sum and/or MD 5 hash, without knowledge of the MD 5 hash table, changing the name or modification of the skin may simply serve to disable the skin, in accordance with one embodiment of the present invention. Since CCM 100 verifies skin 106, MD5 hash tables advantageously provide a deterrent against skin name changes and /or modifications made thereto.

In one embodiment, CCM 100 also includes one or more custom media device driver(s) 107 for providing an even greater measure of control over the media stream while increasing compliance reliability. A client computer system is configured to utilize a custom media device application, e.g., a custom audio device application, a custom video device application, etc., that is emulated by a custom media device driver 107. With reference to audio media, the emulation is performed in a waveform audio driver associated with a custom audio device. Driver 107 is configured to receive a media file being outputted by the system prior to the media file being sent to a media output device, e.g., a video card for video files or a sound card for audio files, etc. In one embodiment, client computer system is configured with a custom media device driver 107 as the default device driver for media file output. In one embodiment, an existing GUI (graphical user interface) can be utilized or a GUI can be provided, e.g., by utilization of a skin 106 or a custom web based player application, for forcing or requiring the system to have driver 107 as the default driver.

Therefore, when a media content file is received by the system, the media content file is playable, provided the media content file passes through the custom media device application, emulated by custom media device driver 107, prior to being outputted. However, if an alternative media player application is selected, delivered media files will not play on the system.

Thus, secured media player applications would issue a media request to the driver for the custom media device which then performs necessary media input suppression, e.g., waveform suppression for audio files, prior to forwarding the request to the default waveform audio driver for audio files.

It is noted that requests for non-restricted media files can pass directly through custom media device driver 107 to a waveform audio driver operable on the system. It is further noted that for either secured media or non-restricted media, e.g., audio media files, waveform input suppression can be triggered by other components of CCM 100, e.g., agents 104, system hooks 105, and skins 106, or a combination thereof, to be active when a recording operation is initiated simultaneously with playback of secured media files.

Advantageously, by virtue of being configured with a custom media device, emulated by a custom media device driver 107, as the default device driver, those media player applications that require their particular device driver to be the default driver, e.g., Total Recorder, etc., are rendered non-functional for secured music. Further advantageous is that an emulated custom media device provides no native support for those media player applications used as a recording mechanism, e.g., DirectSound capture, etc., that are able to bypass user-mode drivers for most media devices. Additionally, by virtue of the media content being sent through device driver 107, thus effectively disabling unauthorized saving/recording of the media files; media files that are delivered in a secured delivery system do not have to be encrypted to provide compliance with copyright restrictions and/or licensing agreements, although, in another embodiment, they still may be encrypted.

### Custom Media Library

A subversive and illegal technique for capturing outgoing copyright media data is addressed and overcome herein. Specifically, the present technology stops a copyright-disregarding recording application from establishing a system hook for the purpose of generating an illegal copy of the copyright media. That is, the present technology redirects calls made by secure media playback applications to unsecure standard operating system services used for rendering the raw media data. In so doing, the system hook is no longer able to intercept the raw media data and therefore no longer able to deliver the intercepted data to illicit recording application 290.

Additionally, since the present technology implements a custom media library utilizing a new pathway at the CCM-enabled playback/recording application to circumvent the illegal copying techniques without interfering or disrupting the commonly used pathway, the computer system maintains the capability of delivering media content that may be legally copied to the recording application while protecting copyrighted digital media content from being illegally copied by the same, or another, recording application.

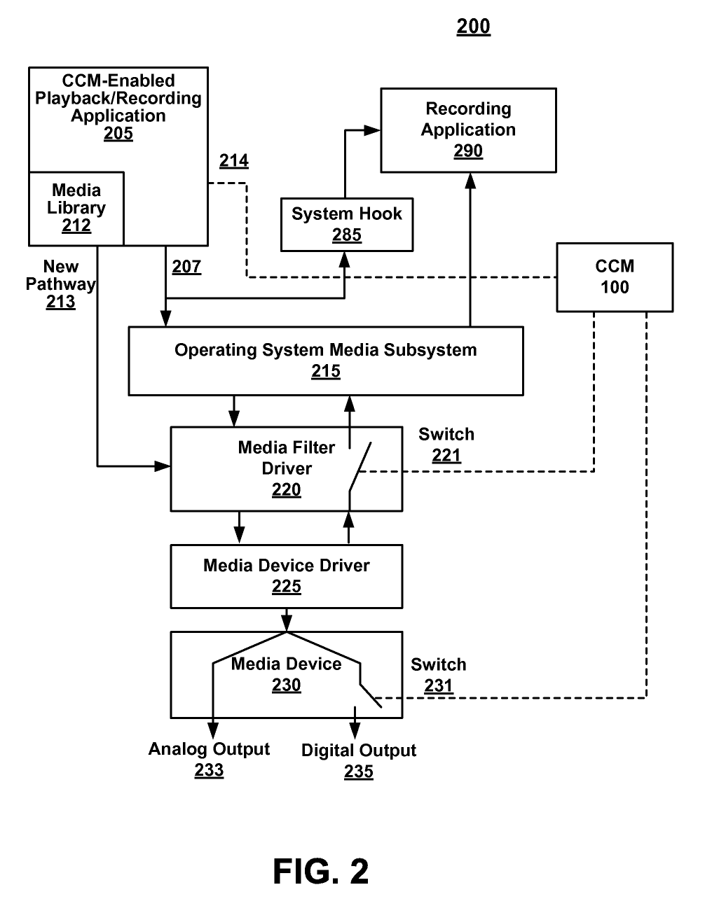

With reference now to FIG. 2, a block diagram of a computer system 200 having a custom media library to secure digital media content is shown in accordance with an embodiment of the present technology. In one embodiment, FIG. 2 includes a number of distinct components and devices for clarity in the discussion. However, in another embodiment, more or fewer components and devices may be present. Further, in yet another embodiment, the components and devices may be combined into one or more components able to perform a number of the actions shown in FIG. 2.

In one embodiment, by utilizing the media library 212 in conjunction with the CCM-enabled playback/recording application 205 and the CCM 100, secure media content may be rendered, played, recorded and copied without the data being in an unsecure environment. In addition, due to the secure environment, in one embodiment no encryption of the media content is necessary.

For example, as illustrated in FIG. 2, when a hooked system service, e.g., OS media subsystem 215, is called, the system hook 285 will gain control of the commonly used pathway 207 first, allowing the recording application 290 to perform application-specific processing before passing control to the actual OS media subsystem 215. The system hook 285 will thus allow the recording application 290 to capture output data without the use of a virtual media device driver or plug-in module.

However, embodiments described herein, overcome this illegal capture technique by incorporating a media library 212 of media functions that make use of lower-level components in the media subsystem, e.g., media filter driver 220, to render secure media data. These lower-level components are not affected by the system hooks 285 that are used by recording applications, and thus copyright protected media can pass securely from the CCM-enabled playback/recording application 205 to a part of the media subsystem, e.g., the media filter driver 220 that is protected by the existing CCM, e.g., CCM 100.

For example, in one embodiment, custom media library 212 provides a secure path for the digital media content as it is delivered from the CCM-enabled playback/recording application 205 to the operating system (OS) media subsystem 215. In one embodiment, media library 212 is able to securely receive the digital media content from the CCM-enabled playback/recording application 205 because it is linked directly into the CCM-enabled playback/recording application 205. That is, media library 212 is not a dll and is not implemented as a standalone object. In other words, because media library 212 is linked directly into the CCM-enabled playback/recording application 205, a system hook 285 is not able to hook digital media content as it is passed from the CCM-enabled playback/recording application 205 to the media library 212.

In addition, in one embodiment, the media library 212 operates below both the kernel mode and the driver level. As such, during the transmission of the digital media from the media library 212 to the media filter driver 220 via new pathway 213, there is no unsecure kernel mode or driver level mode pathways for system hook 285 to “hook”.

For example, instead of using the commonly used pathway 207 to deliver copyright protected media content, such as raw wave data, to an OS media subsystem 215 for rendering, the CCM-enabled playback/recording application 205 will utilize custom media library 212 to generate a new pathway 213 and deliver the raw wave data directly to the media filter driver 220. In other words, in one embodiment, the utilization of media library 212 will provide more general control over the media stream while increasing compatibility and reliability of the overall solution. For example, media library 212 would involve the configuration of new pathway 213 within the computer system 200 to securely deliver the media to a media filter driver 220 at the kernel level.

At the same time, the CCM-enabled playback/recording application 205 will inform CCM 100, via communication pathway 214, that copyright protected raw data will be received at media filter driver 220 and that protection is to be enabled at the kernel mode. As described herein, the CCM 100 is able to protect the copyright protected media by, in one embodiment, instructing the media device driver 225, via switch 221, to suppress waveform input operations. Moreover, in some cases, the CCM 100 may also instruct media device 230, via switch 231, to suppress waveform output operations such as digital output 235.

Thus, in one embodiment, controlled media directed for rendering at the OS media subsystem 215 will first pass securely from the secure CCM-enabled playback/recording application 205 to the media filter driver 220 and then remain secure during rendering by CCM 100.

In one embodiment, requests for non-secure media traffic would also be controlled by media library 212 utilizing the new pathway 213. However, in another embodiment, requests for non-secure media traffic may pass directly from the CCM-enabled playback/recording application 205 to the OS media subsystem 215 via the commonly used pathway 207. When passing the media directly from the CCM-enabled playback/recording application 205 to the OS media subsystem 215 via the commonly used pathway 207, the media would be susceptible to system hook 285 and recording application 290. Of course, since the media utilizing the commonly used pathway 207 is uncontrolled, utilizing the system hook 285 in an attempt to obtain a subversive copy of the media would be immaterial since the media may be legally copied.

In another embodiment, for media devices 230 that support “standard” streaming at the kernel level, the OS media subsystem 215 may issue a request to the media device 230 for each block of data to be read for a capture operation. In one embodiment, if the media is controlled, the CCM 100 can intercept each request, such as at switch 221 and control the content in the data buffer that is returned to the OS media subsystem 215. As stated herein, the CCM 100 control can include (but is not necessarily limited to) the muting of the waveform data, and the introduction of distortion into the media stream.

For media devices 230 that either support “looped” streaming or the WaveRT port type, the OS media subsystem 215 may issue one or more requests at the start of the capture operation to either provide the location of the application-specific media buffer to be used for the operation or obtain the address of the driver-provided capture buffer. The OS media subsystem 215 will then pass data directly to the recording application 290 using these buffers, and thus the CCM 100 will be unable to monitor the data stream during the capture operation. In one embodiment, to prevent unauthorized recording for media devices 230 supporting these techniques, the CCM 100 will instruct the media device 230 to stop the capture operation at switch 221 and/or switch 231. If the recording application 290 or OS media subsystem 215 attempts to subsequently restart the capture, the CCM 100 will detect the restart request and prevent the request from being serviced by the media device 230.

For the purpose of clarification, “standard” streaming is the technique where multiple data buffers are used to stream audio data, with the kernel acting upon one buffer at a time. “Looped” streaming uses a single shared buffer, with the client and the kernel acting upon different regions within the buffer. “WaveRT” uses a mechanism similar to looped streaming, except that the buffer is allocated and managed by the audio device rather than the kernel.

As described herein, the CCM 100 will monitor the system 200 for unauthorized capture operations. Upon detection of such operations, CCM 100 can respond by continuing to allow playback of secure media data while controlling media capture, or to control the playback of the media data. This control can include (but is not necessarily limited to) the muting of waveform input or output, and the introduction of distortion into the media stream.

Thus, by utilizing the technology described herein, that is, the secure delivery of copyright protected media via the media library 212 using the user mode new pathway 213 and the CCM 100, unsecure OS media subsystem 215 is bypassed and the digital media content is passed to lower level media components, such as media filter driver 220, protected by the CCM 100. Then, when the copyright protected digital media content is then passed from the media filter driver 220 to the OS media subsystem 215 for rendering, it is already protected by the CCM 100 and the previously utilized direct sound pirate system hook 285 will no longer be able to access the media.

In other words, the copyright protected media remains in a secure environment the entire time it is on the computer system 200. Because the computer system 200 provides a secure environment for the copyright protected media, in one embodiment no additional measures, such as encryption, or the like on any or all of the copyright protected media are necessary for ensuring copyright compliance.

### Royalty Collection

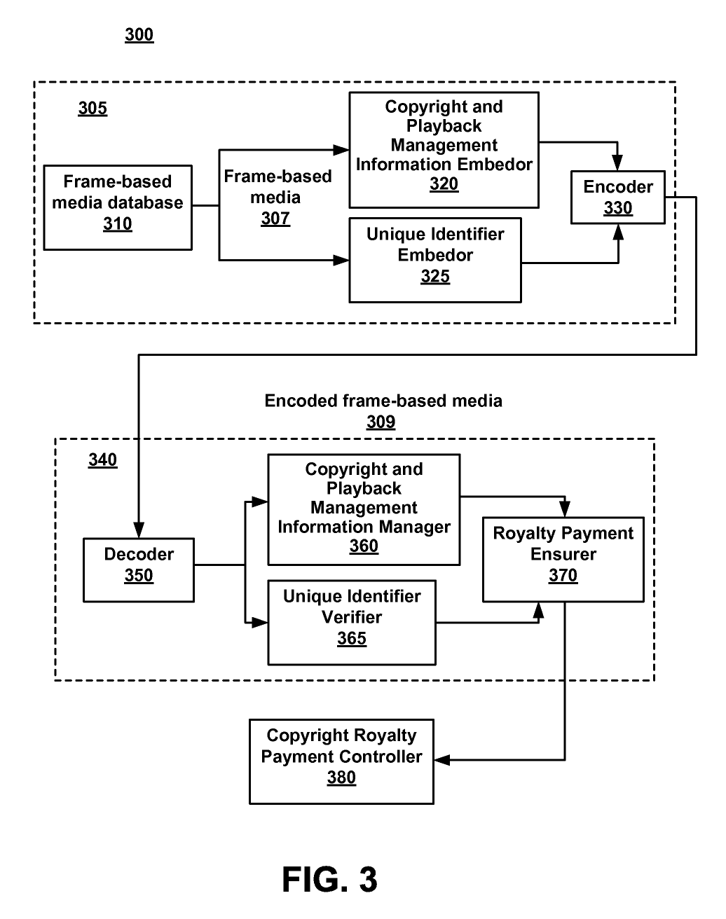

A media provider, such as a media web broadcaster, that provides a large database of media, such as but not limited to sound recordings, may transmit large volumes of copyrighted media and may be required to pay large amounts of royalty fees. An embodiment in accordance with the present invention provides a system 300 for enhancing copyright revenue generation, as illustrated in FIG. 3. System 300 includes a system 305, a device 340 and a copyright royalty payment controller 380. The system 305 includes a frame-based media database 310, a copyright and playback management information embedor 320, a unique identifier embedor 325 and an encoder 330.

The system 305 facilitates in the enhancing of copyright revenue generation by facilitating in the ensuring of appropriate payment of entitled copyright royalties. In one embodiment, the system 305 is a web broadcaster that broadcasts multimedia via the Internet. It should be appreciated that the multimedia is any frame-based media 307 which is stored in a frame-based media database 310. In one embodiment, the frame-based media 307 are MPEG-1 Audio Layer 3 (MP3) files.

In one embodiment, the system 305 facilitates the ensuring of appropriate payment of entitled copyright royalties of copyright works by introducing technological measures to the a copyright protected frame-based media 307 by way of copyright and playback management information embedor 320. In another embodiment, the system 305 facilitates the ensuring of appropriate payment of entitled copyright royalties of copyright works by introducing technological measures to the copyright protected frame-based media 307 by way of unique identifier embedor 325.

It should be appreciated that the copyright and playback management information can be but is not limited to a SCMS. SCMS is a scheme to protect copyrights of digital productions by preventing data from being repeatedly copied. SCMS is built into a media appliance which has a function to create a copy of digital data, such as an MP3 file. The media appliance with the SCMS built into it can prevent a first-generation copy recorded by the user from being copied again. In other words, the SCMS prevents a second or higher generation copy from being created.

Copyright and playback management information embedor 320 embeds copyright and playback management information within frame-based media 307. It should be appreciated that the copyright and playback management information is any information related to the management and/or the enforcement of copyright protection associated with a copyright protected work. In various embodiments, the copyright and playback management information can be but is not limited to the number of copies allowed of the frame-based media, the number of copies allowed of the frame-based media, version number of the frame-based media or no copies allowed, rules for subsequent copies and the like, as well as the number of plays allowed of the frame-based media and the types of devices that are allowed to play the media.

In one embodiment, the copyright management information indicates which machine, product and/or company the copyright protected work came from and/or is allowed to be played back on. It should also be appreciated that the copyright management information may be forensics related information, such as but not limited to tracking information. Further, in one embodiment, the copyright management information is an expiration date(s) associated with the copyright protected work.

It should be appreciated that the copyright and playback management information embedor 320 embeds copyright and playback management information within at least one data field of the frame-based media 307. In one embodiment, the data field is an application-private bit of a MP3 file. Typically, MP3 files are segmented into thousands of frames. For example, a three to five minute song can have approximately 8,000 to 12,000 frames. Each frame contains a fraction of a second's worth of audio data. At the beginning of every data frame is a header frame which stores 32 bits of meta-data related to the coming data frame. The MP3 header begins with a sync block that consists of 11 bits. The sync block allows players to search for and lock onto the first available occurrence of a valid frame. Following the sync block are a plurality of other header blocks that facilitate in the proper decoding and subsequent playing of the MP3 file. One of the other header blocks is the application-private bit, which allows for application-specific triggers. For example, if there are 8,000 frames in an MP3 file, there is a private bit corresponding to each frame for a total of 8,000 private bits.

In one embodiment, the copyright and playback management information is a multiple bit data structure using the application-private bits in the MP3 frame headers across consecutive audio frames. For example, if the copyright and playback management information contains 32 bits, then each bit is stored in 32 consecutive application-private bits in corresponding 32 consecutive frames. In particular, the first bit of the copyright and playback management information is stored in the application-private bit of the header for the first audio frame. The second bit of the copyright and playback management information is stored in the application-private bit of the second audio frame and so on until all the data in the copyright and playback management information is stored in consecutive frames.

Further, the sequence of bits associated with the copyright and playback management information data block is continuously repeated throughout the entire audio file. Once the entire data block has been encoded, the first bit of the copyright and playback management information data block is stored in the application-private bit of the header for the next frame within the MP3 file. Accordingly, the playback application is able to detect the copyright and playback management information for the audio file irrespective of the starting position within the file from which the playback was initiated. For example, if the MP3 file has 8,000 frames and a corresponding 8,000 application private bits, then a copyright and playback management information data block of 32 bits is initially stored in the first 32 consecutive application-private bits and repeatedly stored in consecutive application-private bits, for a total of 250 consecutive and repeated instances of the copyright and playback management information data block stored in the entire MP3 file.

In one embodiment, the copyright and playback management information (CMI) is a 32-bit data structure having the following format. It should be appreciated that the 32-bit data structure is a SCMS data structure used to encode playback rights information in addition to copy control information. For example, a copyright holder may choose to allow a particular work to be played freely a certain number of times before requiring a license key or other access mechanism.

Elements of the 32-bit data structure are shown in Table 1:

| Offset | Description |
|---|---|
| 0 | First byte of CMI, set to fixed value to facilitate detection |
| | by a playback or secure copy/playback application |
| 8 | Second byte of CMI, set to fixed value to facilitate |
| | detection by a playback or secure copy application |
| 16 | Version number of CMI (three binary bits) |
| 19 | Flag indicating copying not allowed for media file |
| 20 | If bit at offset 19 is not set, number of copies allowed for file |
| | (up to a maximum of 15). A value binary 0000 indicates |
| | that the file may be freely copied. |
| 24 | Number of plays allowed for file (up to a maximum of 255). |
| | If this field is set to binary 00000000, the file can be |
| | freely played. |

Additional security is available by using an encryption mechanism. Specifically, an encoder generates one or more sequences of data bytes to be used as keys for the encoding of the media data for the file. The key sequences can be derived from a cryptographically secure digest taken across all or part of the data for the file. Thus, the key sequences are most likely different for each media file.

The key sequences that are used for the encryption for all or part of the SCMS data block are unique to each copyright protected work. The key sequences can be generated using data from the copyright protected work. Thus the SCMS data block can be used to help ensure the integrity and authenticity of the copyright protected work.

It should be appreciated that to allow playback devices to more easily detect the presence of copyright and playback management information, the two marker bytes for each copyright and playback management information data block can be left unencoded.

In one embodiment, system 305 facilitates in the ensuring of appropriate payment of entitled copyright royalties of the copyright protected frame-based media 307 by adding technological measures to the frame-based media via unique identifier embedor 325. Unique identifier embedor 325 embeds at least one unique identifier into a frame-based media file. In one embodiment, the at least one unique identifier is invariant and is embedded into metadata, such as but not limited to an ID3V2 tag. Further, in one embodiment, at least one unique identifier may be a valid copyright registration number from the United States Copyright Office associated with copyright protected frame-based media 307. In another embodiment, at least two copyright registration numbers are embedded into ID3V2 tags of an MP3 file.

System 305 encodes the frame-based media subsequent to the copyright and playback management information embedor 320 embedding copyright and playback management information into the frame-based media 307 and/or the unique identifier embedor 325 embedding at least one unique identifier into the frame-based media 307.

Transcoding can be performed on a frame-based media that results in frameless media. For example, an MP3 file can be transcoded into another format (e.g., wav, AC3), such that it loses its frames, header, footer and as a result all that is left are the payloads. In a frameless media file, the copyright and playback information can be encoded by selecting a certain frequency not usually perceived by the listener and then changing its value to reflect the copyright and playback information data. For example, if a low frequency is selected and sampled, such that there is a guaranteed match on a significant pattern, the copyright and playback information can be further read for copyright and playback rules.

Media device 340 includes a decoder 350 that decodes the encoded frame-based media 309, copyright and playback management information manager 360, unique identifier verifier 365 and royalty payment ensurer 370. Copyright and playback management information manager 360 manages the frame-based media 307 according to the copyright and playback information that is embedded into the frame-based media.

Unique identifier verifier 365 verifies that the at least one unique identifier embedded in the decoded frame-based media is the same unique at least one unique identifier that was embedded into the frame-based media 307. In one embodiment, unique identifier verifier 365 verifies that the two copyright registration numbers associated with the MP3 file embedded in the ID3V2 tags of an MP3 file are the same two copyright registration numbers associated with the MP3 file embedded in the ID3V2 tags subsequent decoding of the MP3 file in the device 340. It should be appreciated that if the unique identifier verifier 365 determines that the at least one unique identifier decoded at device 340 is the same as the at least one unique identifier that was embedded into the frame-based media 307, then it helps determine that the decoded frame-based media 307 has not been tampered with and is not a counterfeit. It should also be appreciated that the ID3V2 tags are metadata in the MP3 frame headers, as described above.

In one embodiment, the royalty payment ensurer 370 facilitates in ensuring appropriate payment of entitled copyright royalties of the copyright protected frame-based work 307 based at least in part on the embedded copyright and playback management information. In another embodiment, the royalty payment ensurer 370 facilitates in ensuring appropriate payment of entitled copyright royalties of the copyright protected frame-based work 307 based at least in part on the embedded at least one unique identifier. Typically, the copyright owner of a copyright protected work is entitled to copyright royalties upon the transmission of a frame-based media 307. Based at least in part upon the output of the copyright management information manager 360 and the unique identifier verifier 366, the copyright owner of the frame-based media is ensured appropriate payment of entitled royalties.

The copyright royalty payment controller 380 receives information from the device 340 and pays the copyright owner of the copyright protected work for the use of the copyright protected work accordingly. It should be appreciated that the copyright royalty payment controller 380 can be but is not limited to a performing rights organization (e.g., The American Society of Composers, Authors and Publishers, Broadcast Music, Inc., SESAC, Inc. and SoundExchange) and/or mechanical rights agency (e.g., Harry Fox Agency and Canadian Mechanical Rights Reproduction Agency).

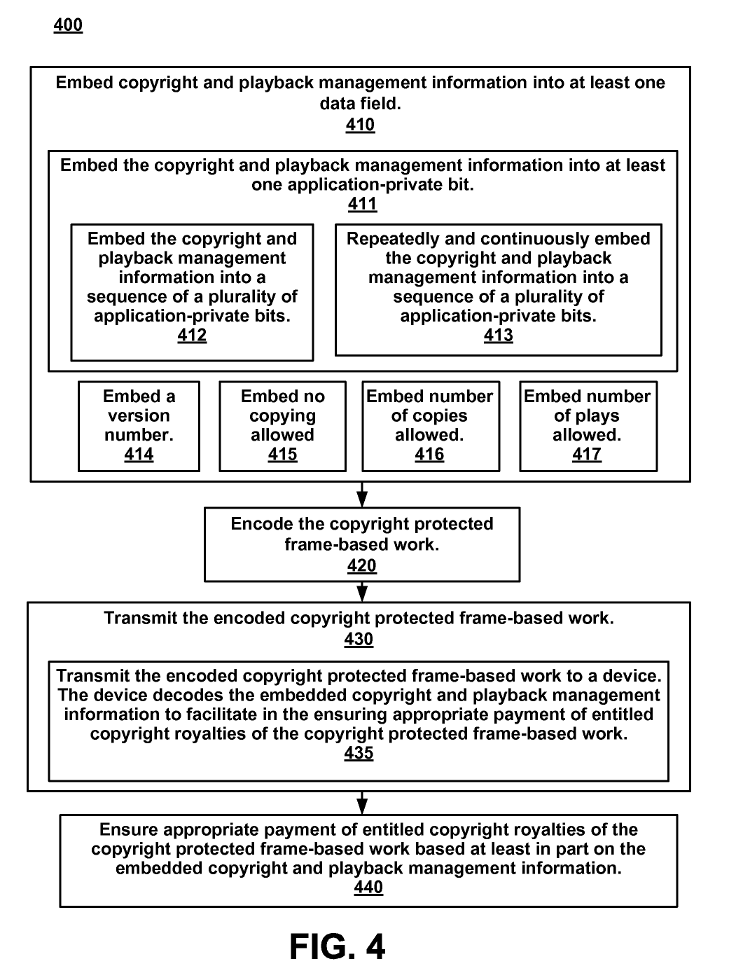

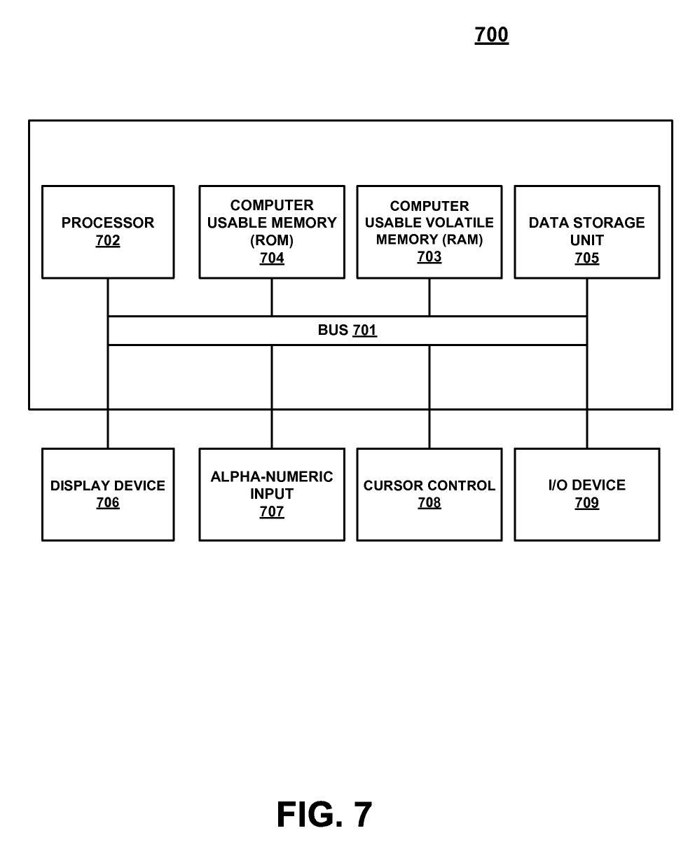

FIG. 4 is a flowchart illustrating a process 400 for enhancing copyright revenue generation. In one embodiment, process 400 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In one embodiment, process 400 is performed at least by system 700 of FIG. 7.

At block 410 of FIG. 4, copyright and playback management information is embedded into at least one data field of the copyright protected frame-based work. The copyright and playback management information corresponds to access to the copyright protected frame-based work. In one embodiment, at block 411, the copyright and playback management information is embedded into at least one application-private bit of at least one corresponding frame of a MP3 file. In another embodiment, at block 412, the copyright and playback management information is embedded into a sequence of a plurality of application-private bits. In another embodiment, at block 413, the copyright and playback management information is repeatedly and continuously embedded into a sequence of a plurality of application-private bits.

In another embodiment, at least two unique identifiers are embedded into at least two data fields of the copyright protected frame-based work. The embedding of the at least two unique identifiers corresponding to access to the copyright protected frame-based work. For example, the at least two unique identifiers may be embedded into an ID3V2 tag of at least one corresponding frame of a MP3 file. In another embodiment, a copyright registration number for an underlining sound recording and/or an underlining composition corresponding to the copyright protected frame-based work is embedded into the frame-based work.

In yet another embodiment, an audio frequency is selected that is not usually perceived by a listener of the copyright protected work. The copyright protected work is a frame-based work that is transcoded to a frameless work. For example, the copyright and playback management information is encoded within the selected audio frequency not usually perceived by a listener of the copyright protected work.

At block 414, the copyright and playback management information is a version number of the work. At block 415, the copyright and playback management information is no copying allowed of the work. At block 416, the copyright and playback management information is a number of copies allowed for the work. At block 417, the copyright and playback management information is a number of plays allowed for the work.

At block 420, the copyright protected frame-based work is encoded. At block 430, the encoded copyright protected frame-based work is transmitted. In one embodiment, at block 435, the encoded copyright protected frame-based work is transmitted to a device. The device decodes the embedded copyright and playback management information to facilitate in the ensuring appropriate payment of entitled copyright royalties of the copyright protected frame-based work. At block 440, appropriate payment of entitled copyright royalties of the copyright protected frame-based work is ensured based at least in part on the embedded copyright and playback management information.

### Secure Copy/Playback

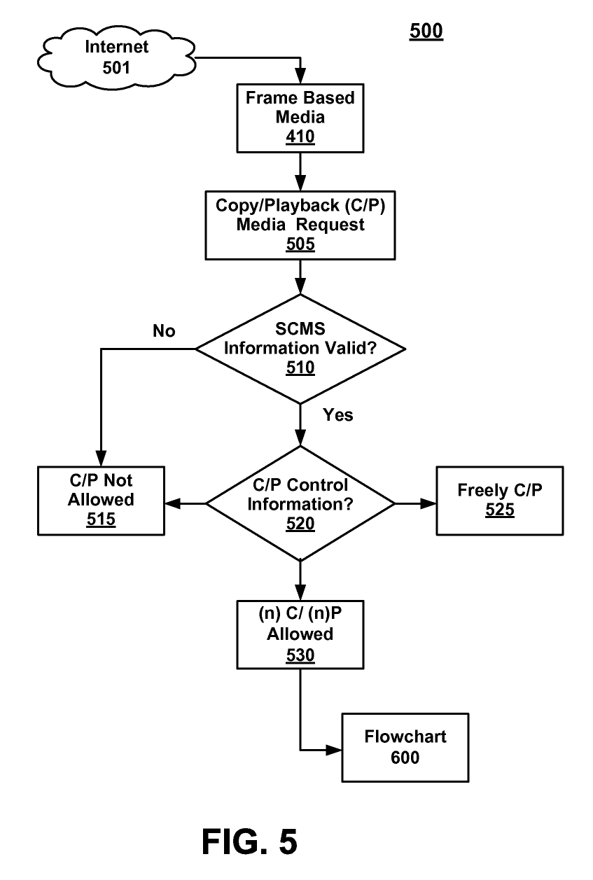

With reference now to FIG. 5, a flow chart 500 of a method for determining if secure media copying and/or playback (C/P) of digital media content in a usage protected frame-based work is allowed is shown in accordance with an embodiment of the present invention. In one embodiment, the method described herein provides a number of rules that a secure copy/playback application may follow in order to be compliant with SCMS and CMI. While the following rules are provided as one exemplary embodiment for secure copy and/or playback limitation, it should be understood that in other embodiments, additional rules may be added or presently provided rules may be ignored. Moreover, in the present discussion, the term copy is utilized, however in alternate embodiments, copying may be replaced by terms such as duplication, sharing, and the like.

With reference now to 501 of FIG. 5, one embodiment utilized the Internet to deliver multimedia broadcasts. It should be appreciated that the multimedia may be any frame-based media 107 stored in a frame-based media database 110. In one embodiment, the frame-based media 107 are MPEG-1 Audio Layer 3 (MP3) files. The methods and systems described with respect to FIGS. 1-4 may then be performed on or utilized with respect to the multimedia.

Referring now to 505 of FIG. 5, a copy and/or Playback (C/P) media request is generated.

With reference now to 510 of FIG. 5, the frame based media 410 is checked for valid SCMS information. In one embodiment, the following terms are utilized to clarify and differentiate between the numerous possible configurations of frame-based media 410. For example, the original frame-based media 410 will either have valid SCMS data or it will have invalid or missing SCMS data. Original frame-based media 410 having invalid or missing SCMS data is also referred to herein as a destination file.

As shown at 515, a destination file of frame based media 410 is a C/P not allowed version. For example, the SCMS frame-based work will not permit a destination file to be copied if it can be definitively determined that the source file has no SCMS information. In one embodiment, although the copying and playback control utilize the same structure, it does not mean that a no-copy file is an unplayable file or that an unplayable file is a no-copy file. In other words, it is quite possible that a user will have a media file that does not contain SCMS information. As such, although a copy may not be allowed, it does not mean that the file cannot be freely played.

For example, in one embodiment, the media file may be from a source that did not include SCMS information. As such, the secure copy/playback application would ensure no-copies are made, thereby supporting owner copyrights. However, the secure copy/playback application may not necessarily stop the file from being played.

In another embodiment, if the media file does not contain SCMS information, the secure copy/playback application may not allow copying or playback of the media.

With reference again to 515 of FIG. 5, if the source file has detectable SCMS information, but the information is either corrupt or internally inconsistent, then the secure copy/playback application should not copy the file. Again, in one embodiment, the playback of the file may also be not allowed.

The following examples illustrate a few of the plurality of possible cases where tampering of the SCMS information in a frame-based MP3 file can be suspected.

If the MPEG audio tag or ID3v2 tag for the media file has been modified, the encoded portion of the SCMS data block will decode to invalid information.

If the application-private bits for some of the MP3 frame headers have been modified, but not all of the frame headers, then one or more valid SCMS data blocks may be detected within the file.

In contrast, in one embodiment, the file may be considered to have valid SCMS information based on heuristics including, but not limited to:

An SCMS marker sequence is found at least once within the media file.

The copyright, original, and protect bits are set in all of the media frames for the file.

Fields within the SCMS data block that are marked as reserved are set to zero, and version information is set to a recognized value.

In another embodiment, the file will have valid SCMS information if all of the following conditions are met:

For every media frame in the file, the frame header has the copyright, original, and protect bits set.

SCMS data blocks are found throughout the entire media file, and these data blocks have valid formats. Specifically, each SCMS data block has the correct two-byte marker, the version field corresponds to a recognized version of the SCMS specification, and the reserved field is set to a value of zero.

In one embodiment, it is possible for an encoding application to set the application-private bits in the frames for an MP3 file to arbitrary values. It is also possible that an encoding application will use the application-private bit for its own purposes. In general, the utilization of the application-private bit will not necessarily invalidate the SCMS information.

With reference now to 520 of FIG. 5, in one embodiment, original frame-based media 410 having valid SCMS data will include C/P control information such as the information 410-417 of FIG. 4. For example, information addressing the number of copies (n) allowed to be made or playbacks allowed to be played. The number of copies (n) or playbacks will normally be defined by the copyright owner or distributor. In general, the number of copies (n) and or the number of playbacks will fall into one of three categories: n=unlimited, n=a certain number and n=0. In general, the number of playbacks does not need to correlate with the number of copies. Although, in one embodiment, as described in further detail herein, the number of playbacks may be established for each copy during the copying of the file.

At 525 of FIG. 5, a frame-based media 410 having valid SCMS data that has a value n=unlimited is referred to herein as an unlimited file. In one embodiment, an unlimited file may be freely C/P. Moreover, an unlimited file may be C/P by, or outside of, the secure copy/playback application defined in flowchart 600.

In contrast, at 515 of FIG. 5, a frame-based media 410 having valid SCMS data that has a value n=0 would be similar to C/P not allowed 415 of FIG. 4, also referred to herein as a destination file. In other words, if the copy control information specifies that copying is not permitted for the file, then the secure copy/playback application should not copy the file. Additionally, if the original bit in any of the MP3 frame headers for the source file is not set, then the secure copy/playback application should not copy the file, irrespective of the state of the original bits in the headers for the other frames in the file. Moreover, in one embodiment, if the source file is copy protected, or otherwise cannot be modified, then the secure copy/playback application should not copy the file.

However, although in one embodiment the copying and playback control utilize the same structure, it does not mean that a no-copy file is an unplayable file or that an unplayable file is a no-copy file. In other words, although the copy and/or playback utilize the same processes, in one embodiment, they are independent. Thus, it is quite possible that a user will have a no-copy media file that may be freely played.

With reference to 530 of FIG. 5, in one embodiment a frame-based media 410 having valid SCMS data that provides for a limited number (n) of copies and/or a limited number of playbacks allowed such as shown at 416 of FIG. 4, is referred to herein as a source file. For clarity, the following discussion is directed toward a source file that is allowed to be copied a total of (n) times. However, in another embodiment, if it is the playbacks that are limited to a certain number (n), the number of playbacks may be similarly controlled. In yet a further embodiment, both the number of copies and the number of playbacks may be simultaneously controlled for a given media file.

With respect now to flowchart 600, a method for secure media copying of digital media content utilizing a usage protected frame-based work is shown in accordance with an embodiment of the present invention. For example, once the copy control information at 520 and 530 of FIG. 5 specifies that the creation of one or more copies is allowed, secure copy/playback application 612 will make a destination file 625 of source file 610.

In one embodiment, secure copy/playback application 612 generates a target file 615 before initiating the copy process. In general, target file 615 is a working copy of source file 610. In one embodiment, the target file is an exact duplicate of the source file including the (n) value. The secure copy/playback application will then utilize target file 615 to generate the destination file 625 and the source file 630. In so doing, if any copying errors damage the file being copied, it is target file 615 that is damaged and not source file 610. In another embodiment, secure copy/playback application 612 may not utilize a target file 615 and may perform the copying process directly from source file 610.

In one embodiment, when target file 615 is copied by the secure copy/playback application 612, the result will include a destination file 625 and a source file 630 having (n−1) available copies remaining. In another embodiment, if secure copy/playback application 612 performs the copying process directly from source file 610, the result may include a destination file 625 and a source file 630 having (n−1) available copies remaining. However, in yet another embodiment, if secure copy/playback application 612 performs the copying process directly from source file 610, the result may include a destination file 625 and a change only to the copy allowance from (n) to (n−1) within source file 610.

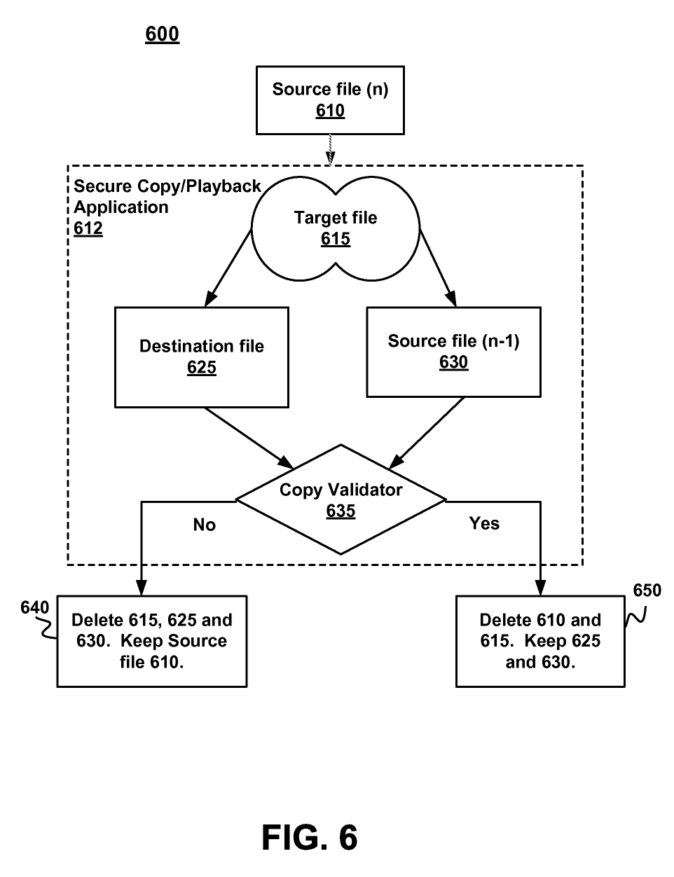

With reference still to FIG. 6, in one embodiment the destination file 625 has valid SCMS information specifying that copies are not permitted. In addition, in one embodiment, the original media bit in the MP3 frame headers for the destination file 625 should not be set, but the copyright and protect bits should be set.

In one embodiment, when source file 630 is created, the copy control information for source file 630 is modified to reflect that destination file 625 has also been made. For example, if the copy control information for source file 610 indicated that three copies were permitted (n=3) before the copy operation was performed, then source file 630 would show two allowed copies remaining (n=2). When the last allowed copy is made, the copy control information should be set to indicate that copying is not permitted for source file 630 (n=0). In other words, when the number of copies of the source file reaches (n=0) the two final copies will include a destination file 625 and a source file 630 with (n=0), the difference between the two being that the destination file will not have the original media bits set in the MP3 frame headers. At that time, the frame-based media 410 would no longer be able to be copied.

In one embodiment, validator 635 of FIG. 6 validates destination file 625 and source file 630. For example, as shown at 640, if an error occurs during the copy operation and the copies cannot be validated, the source file 610 is restored, and the target file 615, destination file 625 and source file 630, if created, are deleted. Thus, by utilizing the target file 615 even if the error condition that caused the copy operation to fail deleteriously affects target file 615, the integrity of source file 610 is maintained. In other words, by utilizing the target file 615 the secure copy/playback application is able to without compromising the copy control for the source file 610.

However, with reference now to 650 of FIG. 6, if destination file 625 and source file 630 are validated, then source file 610 and target file 615 are deleted and destination file 625 and source file 630 adjusted to now allowable copies (n−1) are kept. In one embodiment, both flowcharts 500 and 600 may be repeated until no further copying is allowed. In one embodiment, during the generation of the last available destination file, the result of the copying will include two destination files.

Although the example herein utilized 3 copies allowed per source file 610 or 10 playbacks per file, these numbers are provided merely for purposes of clarity within the examples provided. Thus, it is possible that the number of copies allowed or number of playbacks per file may be fixed at a different number and may also vary by content or media type. For example, in one embodiment a media copyright owner may choose another value for the number of copies allowed and/or number of playbacks per file.

Furthermore, in one embodiment, if there is a difference between the rule for the number of copies or plays allowed with respect to the SCMS and the number of copies or plays defined by the copyright owner, the number of copies allowed will default to the lesser of the number of copies. For example, the number of copies allowed may be set to default to the SCMS number of copies allowed as long as it is not larger than the copyright owner's suggested number of copies.

In another embodiment, if the copyright owner and the SCMS have a differing number of copies allowed rules (e.g., SCMS (4) copies; copyright owner (6) copies), a hierarchical rule may be utilized such that preference is provided to one over the other regardless. For example, the number of copies allowed would become the copyright owner's suggested number of copies (6).

### Example Computing System

Referring now to FIG. 7, a diagram of computer system 700 in accordance with one embodiment of the present invention is shown in greater detail. Within the discussions certain processes are discussed that are realized, in one embodiment, as a series of instructions that reside within computer readable memory units of system 700 and executed by processor 702 of system 700. When executed, the instructions cause the computer system 700 to perform specific functions and exhibit specific behavior as described.

In general, computer system 700 used by the embodiments of the present invention comprises an address/data bus 701 for communicating information, one or more central processors 702 coupled with the bus 701 for processing information and instructions, a computer readable volatile memory unit 703 (e.g., random access memory, static RAM, dynamic, RAM, etc.) coupled with the bus 701 for storing information and instructions for the central processor(s) 702, a computer readable non-volatile memory unit 704 (e.g., read only memory, programmable ROM, flash memory, EPROM, EEPROM, etc.) coupled with the bus 701 for storing static information and instructions for the processor(s) 702.

System 700 also includes a mass storage computer readable data storage device 705 such as a magnetic or optical disk and disk drive coupled with the bus 701 for storing information and instructions. Optionally, system 700 can include a display device 706 coupled to the bus 701 for displaying information to the computer user (e.g., maintenance technician, etc.), an alphanumeric input device 707 including alphanumeric and function keys coupled to the bus 701 for communicating information and command selections to the central processor(s) 702, a cursor control device 708 coupled to the bus for communicating user input information and command selections to the central processor(s) 702, and a signal generating input/output device 709 coupled to the bus 701 for communicating command selections to the processor(s) 702.

Examples of well known computing systems, environments, and configurations that may be suitable for use with the present technology include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

What is claimed is:

1. A method for using a custom media library to secure digital media content on a computing system, said method comprising:
directly linking said custom media library with a copyright compliance mechanism (CCM)-enabled playback/recording/recording application;
utilizing said custom media library to generate a new pathway distinct from a commonly used data pathway of said CCM-enabled playback/recording application and a media rendering subsystem of an operating system;
alerting a CCM to monitor a plurality of media subsystems of said computing system; and
securely passing a raw media file from said CCM-enabled playback/recording application via said custom media library and over said new pathway to a media subsystem of said operating system that is monitored by said CCM, such that said raw media file continuously remains in a secure environment during rendering, playback and recording.

2. The method of claim 1 further comprising:
directly linking said custom media library with said CCM-enabled playback/recording application such that said custom media library is hard linked into said CCM-enabled playback/recording application.

3. The method of claim 1 further comprising:
utilizing said new pathway to bypass said media rendering subsystem of said operating system.

4. The method of claim 1 further comprising:
utilizing said custom media library to generate said new pathway at the user mode.

5. The method of claim 4 further comprising:
utilizing said new pathway to link said custom media library with a kernel mode said media subsystem of said operating system monitored by said CCM.

6. The method of claim 4 further comprising:
utilizing said new pathway to link said custom media library with a driver level said media subsystem of said operating system monitored by said CCM.

7. The method of claim 1 further comprising:
securely passing said raw media file from said media subsystem of said operating system that is monitored by said CCM to said media rendering subsystem such that a copyright of said raw media file is protected.

8. The method of claim 1 further comprising:
accessing a serial copy management system information for said digital media content; and
validating said serial copy management system information.

9. The method of claim 8 further comprising:
accessing copy and playback management information associated with said digital media content; and
utilizing said copy management information to determine if a secure copy and playback application is authorized to generate a copy of said digital media content.

10. A system for secure and controlled digital media content rendering comprising:
a media library directly linked with a copyright compliance mechanism (CCM)-enabled playback/recording application;
a new pathway generated by said custom media library at the user mode, said new pathway distinct from a commonly used data pathway of said CCM-enabled playback/recording application and a media rendering subsystem of an operating system;
an informing generator informing a CCM to monitor a plurality of media subsystems on a computing system, such that a raw media file is securely passed from said CCM-enabled playback/recording application via said custom media library and over said new pathway to a media subsystem of said operating system that is monitored by said CCM, such that said raw media file continuously remains in a secure environment during rendering, playback and recording.

11. The system of claim 10 wherein said new pathway initially bypasses said media rendering subsystem of said operating system and is only provided to said media rendering subsystem from within the secure CCM.

12. The system of claim 11, wherein utilizing said new pathway to link said custom media library with a kernel mode said media subsystem of said operating system or a driver level said media subsystem of said operating system monitored by said CCM.

13. The system of claim 10, further comprising:
a computer storage medium having instruction stored therein, said instructions when executed causing a computer system to perform secure and controlled copying and playback of a digital media content, said instructions comprising:
a source file receiver receiving a source file of said digital media content, said source file having (n) copy and (n) playback management information associated therewith;
a destination file generator generating a destination file based on said source file of said digital media content said destination file having (0) copy and (n) playback management information associated therewith;
a modified source file generator generating a modified source file based on said source file of said digital media content said modified source file having (n−1) copy and (n) playback management information associated therewith; and
a validator validating said destination file and said modified source file based on said source file of said digital media content.

14. A computer readable medium having computer implementable instructions stored thereon, said instructions for causing a compliance mechanism to perform a method for using a custom media library to secure digital media content on a computing system, said method comprising:
directly linking said custom media library with a copyright compliance mechanism (CCM)-enabled playback/recording application;
utilizing said custom media library to generate a new pathway at the user mode, said new pathway distinct from a commonly used data pathway of said CCM-enabled playback/recording application and a media rendering subsystem of an operating system, said new pathway bypassing said media rendering subsystem of said operating system;
alerting a CCM to monitor a plurality of media subsystems of said computing system; and
securely passing a raw media file from said CCM-enabled playback/recording application via said custom media library and over said new pathway to a media subsystem of said operating system that is monitored by said CCM, such that said raw media file continuously remains in a secure environment during rendering, playback and recording.

15. The computer readable medium of claim 14 further comprising:
directly linking said custom media library with said CCM-enabled playback/recording application such that said custom media library is hard linked into said CCM-enabled playback/recording application.

16. The computer readable medium of claim 14 further comprising:
utilizing said new pathway to link said custom media library with a kernel mode said media subsystem of said operating system monitored by said CCM.

17. The computer readable medium of claim 14 further comprising:
utilizing said new pathway to link said custom media library with a driver level said media subsystem of said operating system monitored by said CCM.

18. The computer readable medium of claim 14 further comprising:
securely passing said raw media file from said media subsystem of said operating system that is monitored by said CCM to said media rendering subsystem such that a copyright of said raw media file is protected.

19. The computer readable medium of claim 14 further comprising:
accessing a serial copy management system information for said digital media content; and
validating said serial copy management system information.

20. The computer readable medium of claim 19 further comprising:
accessing copy and playback management information of said digital media content; and
utilizing said copy management information to determine if a secure copy and playback application is authorized to generate a copy of said digital media content.
